(19) United States
(12) Patent Application Publication
(10) Pub. No.: US 2011/0083766 A1
(43) Pub. Date: Apr. 14, 2011

(54) Rehabilitation Liner System

(76) Inventor: Richard M. Anders, Port Washington, WI (US)

(21) Appl. No.: 12/900,025

(22) Filed: Oct. 7, 2010

Related U.S. Application Data
(63) Continuation-in-part of application No. 11/747,031, filed on May 10, 2007, now abandoned.
Application No. 11/747,031 is a continuation-in-part of application No. 12/027,504, filed on Feb. 7, 2008, now Pat. No. 7,891,381.
Application No. 12/027,504 is a continuation-in-part of application No. 12/358,646, filed on Jan. 23, 2009.

(51) Int. Cl. F16L 55/16

(52) U.S. Cl. 138/98

(57) ABSTRACT

A cured-in-place liner system for pipe rehabilitation includes an end sealing assembly coupled to an end of a pipe and the cured-in-place liner to prevent water from penetrating the area between the cured-in-place liner and the pipe. A sealing member is provided for sealing off a tap of a lateral pipe from the main pipe to prevent the penetration of resin and other materials into the lateral pipes during the curing process. The sealing member includes a central portion that is placed over an end of the tap and removable after completion of the curing process so that fluids may freely flow between the main pipe and the lateral pipe. A tool assembly for coupling the sealing member and/or a connector between to a lateral pipe is also provided. The tool includes a coupling member attachable to a robotic device and a fixture tool having means for coupling to the sealing member and/or connector.

### CROSS REFERENCE TO RELATED APPLICATIONS

This application claims priority and is a continuation-in-part of U.S. patent application Ser. No. 12/027,504 filed on Feb. 7, 2008 and entitled “Pipe and Tube Rehabilitation Liners and Corresponding Resins,” which is a continuation-in-part of U.S. patent application Ser. No. 11/747,031, filed on May 10, 2007 and entitled “Reinforcing Liner” and U.S. patent application Ser. No. 12/358,646, filed on Jan. 23, 2009 and entitled “Connector for Interconnecting a Lateral Pipe to a Main Pipe,” the entire contents of which are hereby incorporated by reference.

### BACKGROUND OF THE INVENTION

1. Field of the Invention

The present invention relates in general to the field of piping, and more particularly, to the rehabilitation of pipes.

2. Discussion of the Related Art

Various methods of rehabilitating a tube, such as a pipe that is buried underground, are known in the art. Generally speaking, such methods include the use of a liner having a diameter that is substantially the same as the inner diameter of the pipe to be rehabilitated. The liner frequently includes an impermeable layer and an adjacent resin-absorbing layer. This resin-absorbing layer is soaked with a liquid resin prior to the introduction of the liner into the pipe. After being properly positioned in the pipe, the liner is pressed against the inner surface of the pipe by fluid pressure.

Most liners in such applications utilize a layer of nonwoven felt for the resin-absorbing layer of the liner. One of the purposes of the felt is to provide support for the uncured resin of the impregnated liner. The felt serves as a reservoir and/or carrier means for the uncured resin. Once cured, the resin provides the structural strength of the liner.

These so-called cured-in-place liners are typically installed in environments that are continuously exposed to water and other corrosive materials. Cured-in-place liners are also exposed to varying temperatures and flow conditions. Cured-in-place liners may be used to rehabilitate main pipes lateral pipes generally orthogonally interconnected with the main pipe. Of course, lateral pipes may be interconnected at any number of different acute or obtuse angles. Oftentimes it is desirable to utilize a connector like that disclosed in U.S. patent application Ser. No. 12/358,646 to Anders to interconnect a rehabilitated main pipe and a rehabilitated lateral pipe. Of course, such connectors may be used wherein only one of the main and lateral pipes has been rehabilitated or in situations where neither has been rehabilitated.

To connect a lateral pipe to the rehabilitated pipe, an opening is cut into the liner that aligns with either an existing opening in the pipe or a new opening is also cut into the pipe. When securing the lateral pipe to the main pipe, it is imperative that a sealed connection be made to prevent the leakage of fluid at the point of interconnection. Moreover, for applications wherein the fluid is maintained at a heightened pressure, a poor sealing between the main pipe and the lateral pipe can lead to fracture and ultimately failure at the connection. Thus, a connector like that of the Anders application may be utilized to provide an improved seal between the main pipe and the lateral pipe.

One common disadvantage of known cured-in-place liners is that fluids such as, for example, water, sewage and gases as well as at least semi-solid materials are sometimes able to penetrate the seal provided by the liner and able to become lodged between the liner and the pipe in which the liner is fitted. Yet another disadvantage of prior cured-in-place liners is that the curing process may result in resin being introduced into the taps of the lateral pipes if not sealed properly. Thus, the lateral pipes may become clogged and prevent fluids from flowing between the main pipe and the lateral pipes. Moreover, this may result in an unwanted build up of pressure within the main pipe and lateral pipes such that the pipes may become damaged. Accordingly, a cured-in-place liner system that overcomes the foregoing disadvantages is desired.

### SUMMARY AND OBJECTS OF THE INVENTION

The cured-in-place liner system of the present invention includes an end fitting or end seal that cooperates with the liner and the pipe in which the liner is received to prevent the penetration of fluids such as, for example, water or at least semi-solid materials between the liner and pipe. The end seal of the present invention may be coupled to an end of a liner received within a pipe. The end seal may be constructed from a metal such as stainless steel. Alternatively, the end seal may be made from any metal or plastic capable of ensuring a proper fitting between the end seal and the liner system to prevent the penetration of water through the liner. The end seal of the present invention may be incorporated into any distribution line and in particular to distribution lines that are under pressure. This includes, but is not limited to, water, gas, and sewage pipes such as forced main pipes.

The end seal may have a two-piece construction in which one of the pieces of the end seal is secured between a felt sleeve of the liner system and an inverted liner. The second piece may be secured to the other end of the composite liner and define one end of the liner system. The second piece may be coupled to an outer edge of the first piece by way of a number of fasteners.

The first piece of the end seal may be an internal piece or base that is generally hollow and includes a cylindrical body that extends inwardly with respect to the pipe and an annular flange positioned on an outward end of the first piece. The body of the first piece may be a stepped ring. The stepped ring of the first piece may be sized and shaped to receive the felt sleeve to thereby secure the felt sleeve to the stepped ring. In particular, the felt sleeve may be slid over an inner end of the first piece until an outer end of the sleeve abuts against an inner end of the annular flange.

The second, outer piece or cap of the end seal may be similarly constructed as the first, inner piece and include a cylindrical body that extends inwardly with respect to the pipe and an annular flange positioned outwardly with respect to the body. The annular flange may include a number of spaced apertures for receiving fasteners for securing the second piece of the end seal to the first piece. Accordingly, the annular flange of the first piece may likewise include a number of apertures for receiving the ends of the fasteners inserted through the apertures of the first piece of the end seal. The composite liner of the liner system is moved in place over the cylindrical body of the second piece and secured thereto. The body of the second piece may be a stepped ring much like that of the first piece. In one construction of the liner system of the present invention, a caulking material or the like is applied to the stepped ring or body of the second piece prior to the application of the liner. In this manner, a seal is provided between the second piece and the liner to prevent the penetration of water, other fluids, and at least semi-solid materials through the liner and between the liner and the pipe in which the liner is received. The second piece of the end seal may be secured within an inner diameter of an end of the pipe such that it is flush therewith.

In one embodiment of the present invention, a seal member is provided for sealing the connection between the lateral pipes and the main pipe. The seal member may be a saddle or similarly shaped member configured to be received over an end of a tap of a lateral pipe connected with the main pipe in which the liner is being installed. The seal member is configured to prevent the introduction of resin or other materials into the lateral pipes so that the lateral pipes do not become clogged. The seal member includes a cylindrical body configured to be received over an end of the tap of the lateral pipe. The cylindrical body may include a number of tabs configured to engage threads of the tap of the lateral pipe. The cylindrical body may include a centrally disposed portion that is configured to be removed after the liner installation is complete such that fluids such as water and gas and at least semi-solid materials such as sewage are capable of flowing between the main pipe to the lateral pipes.

In one embodiment of the present invention, a fixture tool is provided for application of the seal member to the tap of the lateral pipe. The system may include a block member for operably coupling to a robotic device for engaging with the seal member and/or a connector for interconnecting the main pipe and lateral.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a perspective view of a conventional lining hose appropriately labeled “PRIOR ART”;

FIG. 2 illustrates a perspective view of one embodiment of a member according to the present invention;

FIG. 3 illustrates a schematic view of a material of the present invention;

FIG. 4 illustrates a schematic view of a sandwiched material of the present invention;

FIG. 5 illustrates a schematic view of another material according to the present invention;

FIG. 6 illustrates a schematic view of another material according to the present invention;

FIG. 7 illustrates a cross-sectional view of one portion of the member of the presents invention;

FIG. 8 shows the member of the present invention in place in a pipe.

It should be noted that the shading in the FIGS. is meant to differentiate between the various layers and not to represent a particular material, graphical symbol, or color, unless otherwise indicated;

FIG. 9 is an isometric view of a main pipe and lateral pipe interconnected using a connector according to one embodiment of the present invention;

FIG. 10 is an isometric view of the connector according to one embodiment of the invention;

FIG. 11 is a side elevation view of the connector shown in FIG. 10;

FIG. 12 is a section view taken along line 12-12 of FIG. 9; and

FIG. 13 is a side elevation view of a connector according to another embodiment of the invention;

FIG. 14 is side section view of a rehabilitated pipe;

FIG. 15 is a partial isometric view of a pipe incorporating an end sealing assembly according to the present invention;

FIG. 16 is an exploded view of the end sealing assembly according to the present invention;

FIG. 17 is a top plan view of the pipe incorporating the end sealing assembly of the present invention;

FIG. 18 is a cross-section of the pipe and the end sealing assembly according to the present invention and taken along line A-A of FIG. 16;

FIG. 19 is a cross-section of the pipe and end sealing assembly taken along line B-B of FIG. 18;

FIG. 20 is an isometric view of a seal member according to one embodiment of the present invention;

FIG. 21 is an isometric view of the seal member of FIG. 19 taken from an opposite side of the seal member;

FIG. 22 is an isometric view of the seal member of FIGS. 19-20 in which a central portion of the seal member has been removed;

FIG. 23 is an isometric view of the seal member of FIG. 21 taken from an opposite side of the seal member; and

FIG. 24 is an exploded view of an assembly system according to the present invention.

### DESCRIPTION OF PREFERRED EMBODIMENTS

The present invention and the various features and advantageous details thereof are explained more fully with reference to the non-limiting embodiments described in detail in the following description. In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose. For example, the words “connected”, “attached”, or terms similar thereto are often used. They are not limited to direct connection but include connection through other elements where such connection is recognized as being equivalent by those skilled in the art.

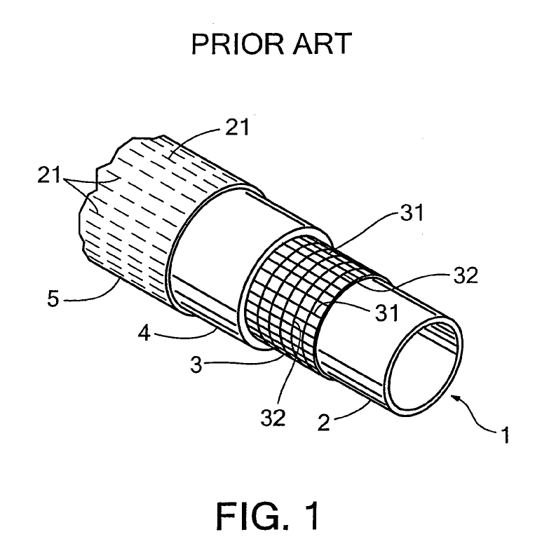

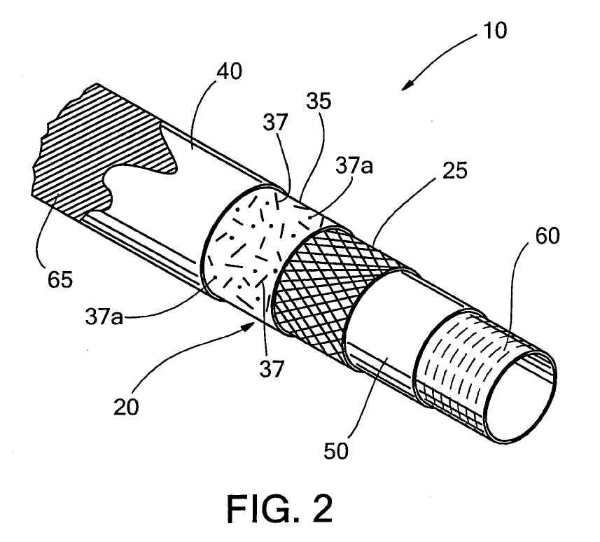

FIG. 1 shows a prior art liner as discussed above, while FIGS. 2-8 show the present invention which includes a liner for reinforcing a tube or pipe. By way of example from U.S. Pat. No. 5,868,169, FIG. 1 of the present application shows lining hose 1 with an inner layer of resin-absorbing material 2 comprising a layer of nonwoven polyester felt of two-eight mm in thickness. The layer of reinforcing fibers 3 is a relatively thin, up to two mm thick, mesh of fiberglass fibers. The outer layer of resin-absorbing material 4 is a two-eight mm thick layer of nonwoven polyester felt. The thickness of the various layers depends upon such factors as the size, length, and depth of a given pipe to be lined. However, it should be noted that the layer of felt can be a deterrent to the strength of the liner after the resin has cured since it occupies space that could otherwise be filled with resin. An impermeable plastic material comprises the outer covering or layer 5. Examples of the plastic material used for layer 5 include polyurethane, polypropylene, and polyethylene.

Prior to inserting the lining hose into the pipe to be lined, the resin absorbent material of lining hose 1 shown in FIG. 1 is soaked with a volume of resin that exceeds the volume required to totally saturate the inner and outer layers of resin absorbent material, layers 2 and 4 respectively. The inner and outer layers of resin absorbent material may be saturated with resin using vacuum impregnation or injection methods that are commonly known in the art. The lining hose 1 must be saturated with a sufficient volume of resin so that the layer of reinforcing fibers 3, as shown in FIG. 1, is encapsulated in resin during both the uncured and cured stages of installation. Reinforcing layer 3 has reinforcing fibers that are shown as longitudinal fibers 31, which are parallel to the longitudinal axis of the lining 1 and radial fibers 32 which are generally radial to that axis.

The introduction of resin may be performed directly at the installation site or at an appropriate off-site location. After the volume of resin has been introduced into the lining hose, the outer covering layer 5 is perforated so as to provide the outer covering layer with flow-through openings 21 as illustrated in FIG. 1.

FIG. 2 is a perspective view of a liner of the present invention. The present invention includes a member 10 which is preferably an inverted liner comprised of a mat 20. The mat 20 includes several components. For example, the mat 20 preferably includes a three-dimensional material 25 adjacent at least one layer of felt material 40. A second felt layer 50 may be added. Between the three-dimensional material 25 and the first felt layer 40 is layer 35 of fiberglass 37 and 37a, which is laid on the felt 40. On the second layer of felt 50, is preferably a coating or cover 60.

Prior to installation, the mat 20 is preferably soaked with a resin 65 that preferably penetrates through all the layers, e.g., 25, 35, 40, and 50.

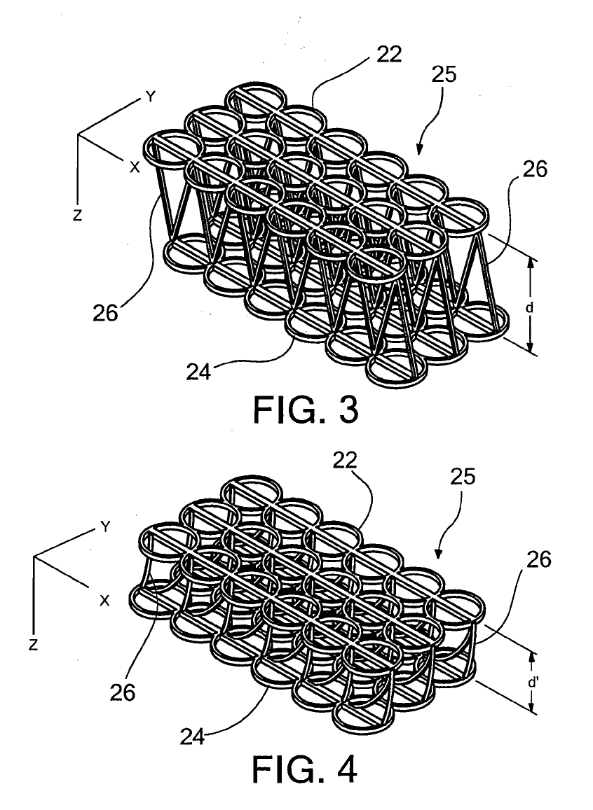

As shown in FIG. 3, the three-dimensional material 25 preferably has a unique knit or weave configuration. Such material 25 may include strands or lengths of polymer materials woven together. The material 25 may also include some fiberglass or carbon in addition to the polymer materials. Polynova, located in Milford, Mass., typically provides such materials and textiles for closed-mold interlaminar vacuum infusion processes. Preferably, the material 25 of the present invention is Polynova's POLYBEAM or HIFLUXF90™ material.

Preferred characteristics of these materials may be as follows:

### POLYBEAM 703 PET:

x,y fiber type: multi-filament polyester (PET)
z fiber type: mono-filament polyester (PET)
areal weight: 0.800 oz./ft.2
infused weight: 2.540 oz./ft.2
thickness: 0.026 inches
roll width: 60 inches std., to 160 inches
roll length: to suit

### HIFLUX90™ PET:

x,y fiber type: high tenacity polyester
areal weight: 1.26 oz./ft.2
infused weight: 5.07 oz./ft.2
thickness: 0.056 inches
roll width: 60 inches std., to 160 inches
roll length: to suit.

Alternatively, instead of HIFLUX90™, the material 25 may be a continuous strand fiberglass that is looped upon itself. This material 25 is preferably an ACR glass Fiber Reinforced Plastic (FRP) mat available from Superior Fibers Inc. of Bremen, Ohio.

Referring again to the drawings, FIG. 3 schematically illustrates a representative fabric material 25 in a free or uncompressed relaxed form. As shown in this illustration of, e.g., HIFLUX90™, there is preferably a pair of outer, generally woven fabric layers 22 and 24 lying generally in the respective X-Y planes. Separating, and disposed between, these layers are a plurality of resilient fibers or yarns 26 lying generally in a “Z direction.” The Z direction fibers need not be at an exact 90-degree orientation, and generally are not. The angle is not critical and may vary substantially, for instance between about 30 degrees and 90 degrees. As indicated, the overall thickness dimension “d” of the fabric may be between about one or two mm up to about 25 or 30 mm, or even more, with presently preferred dimensions in the range of about two mm to about twelve mm.

As FIG. 3 also shows, the Z direction fibers preferably lie between the two outer layers 22, 24. These outer layers may range from an open honeycomb structure to a more tightly woven warp and weft structure.

FIG. 4 schematically represents how the three-dimensional fabric 25 compresses in the Z direction to a lesser thickness “d,” when, for example, it is sandwiched between fabric or felt layers 40, 50, or other layers. Even though compressed, the three-dimensional fabric architecture facilitates hardening agent flow, penetration, and distribution throughout the structure including the surrounding and adjacent layers of the entire laminate lay-up. Moreover, when the fabric or felt layers are needle punched, the agent, e.g., liquid resin 65 (FIG. 2), will have a flow path such that it not only fills the intermediate spaces between fibers 26 of material 25 but also flows laterally so as to also fill and saturate both the outer layers 22, 24 and also adjacent felt or fabric layers 40, 50.

In the past, the problem has been that resin must pass more incrementally as the required infusion distance is increased. Thus, “length losses” accumulate as resin 65 (FIG. 2) travels ever more slowly through the flow medium while encountering approximately the same frequency of the fiber “obstacles”, which also serve as structural reinforcement. Thus, interlaminar infusion, or infusion from within the substrate or laminate, has achieved little adoption in the prior art despite being naturally advantageous as compared to surface infusion techniques like SCRIMPTM, from cost, waste, and property-additive standpoints.

Interlaminar fabric material knit 25 according to this invention, e.g., an added layer, can also be sandwiched and/or placed on either face of the fabric 40, 50 to promote infusion on all sides of the dry laminate, which greatly speeds infusion. Furthermore, this interlaminar material can increase laminate thickness and also allow for better visual quality. The invention further overcomes such problems as incomplete or slow infusion, uneven distribution or pooling of resin, long setup time, material waste, and weakened strength in the finished composite.

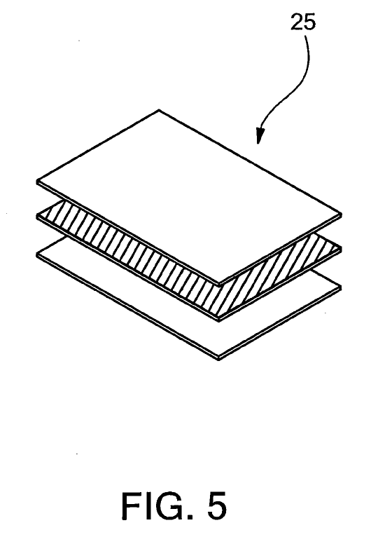

In one embodiment of this invention shown in FIG. 5, the fabric material 25 is constructed of small diameter monofilament polyester, e.g., PET, in the Z plane and with fiberglass yarn, e.g., ECR, on the X/Y fascia planes as both are relatively well-known materials. These materials are preferably knitted together to form the material 25. A reduced diameter and/or stiffness in the Z directional yarn or fiber may require reduced columnar height, and therefore a less free-form thickness of the fiber, to ensure adequate buckling yield and resilient spring-back behind the resin 65 flow front. Despite the reduced free-form thickness, this embodiment may add the same overall thickness to the consolidated laminate as thicker free-form designs.

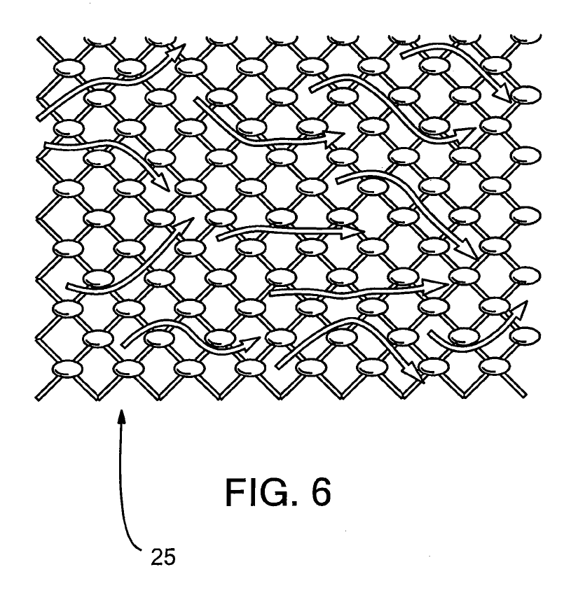

In another embodiment of this invention shown in FIG. 6, a diamond-shaped woven architecture (instead of knitted) provides unique mechanical properties for the three-dimensional material or weave 25 because the fibers are oriented in a preferred direction for strength in the mat laminate 20. The intent of this material is to reduce or eliminate the need for additional reinforcement materials in a given laminate and increase overall cost savings.

The invention also contemplates a fabric design for the material 25, which presents another low-cost material. This product has a similar Z directional structure, but with smooth faces. The X/Y faces here are knitted with multifilament polyester thermoplastics, e.g., PET, with tight face architectures. Smooth faces may help mitigate surface profiling, also known as print. This embodiment also provides an opportunity to use low-cost recycled PET for the multifilament components.

The choice of fibers 37, 37a needle punched in Z direction, e.g., through the fabric 40, 50 and material 25, can be widely varied and the selection thereof is influenced by the mechanical characteristics of the fiber material. These fibers may generally be glass or carbon fibers, although standard carbon fibers are generally not preferred as resiliency and an appropriate bending modulus are the desired characteristics for this element. As indicated, the Z fibers act essentially as joining barbs and also create flow chutes from the outer fabric layers. Therefore, important factors to consider for this selection include a balanced combination of length, column (or denier), spacing, and orientation relative to the outer layers. While deniers of fibers, percentage of glass fiber with respect to other materials, and finished product sizes may vary, the preferred glass content is about 40% by volume 50% by weight, the density is preferably less than one ounce per square yard to fifty-two ounces per square yard and about 1.8-2.2 ounces per square yard, and denier size is about 102-204 with a preferred size of 113. The preferred filament diameter would range about 0.00018-0.00025 with a preference of 0.00023. These have been found to provide sufficient strength and tenacity while maintaining invertibility.

The fiber architecture thereby achieved according to the present invention is optimal for resin 65 infusion processing and can greatly enhance final performance-to-weight properties such as shear strength, rigidity, and damage tolerance. A vast spectrum of physical property enhancements can be further tailored by designing X/Y/Z fiber architectures with hybrid combinations of polyester, glass, carbon, aramid, polyolefin, and/or other materials. The practice of this invention may also provide a relatively low-profile material.

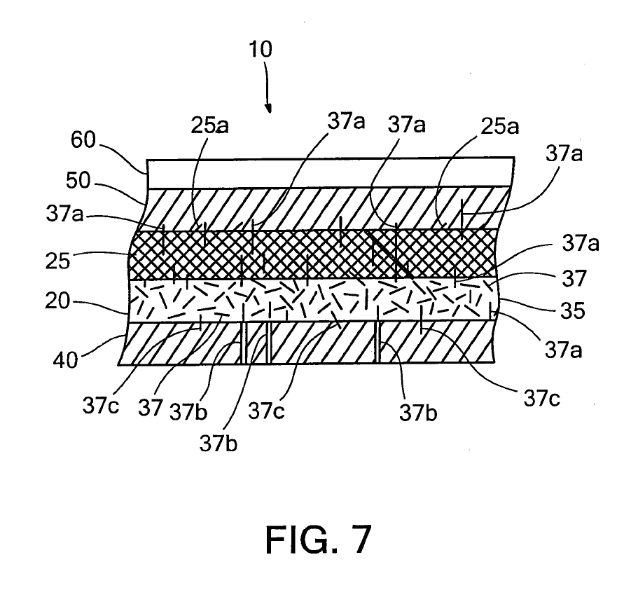

FIG. 7 shows one embodiment of the present invention prior to inversion. In this embodiment, the first layer is a fabric or felt 40. On top of the felt is the ECR fiberglass layer 35. On top of the fiberglass layer 35 is the three-dimensional material 25. Next, preferably is another felt layer 50 and then finally the coating or cover 60.

In this embodiment as shown, there is preferably a top or bottom 22, 24 missing from material 25. Thus, small strands or barbs 25a protrude from the material 25 and into felt layer 50. This preferably occurs when the layers 25, 35, 40, and 50 are sandwiched together by the compression process. The needling process preferably takes place before the coating 60 is added. During the needling process, a small needle (not shown) punches the layers and thus creates small channels 37b in the layer 40. As the needles penetrate through to the fiberglass layer 35, some pieces of fiberglass 37a are pushed into a perpendicular orientation. As shown, not all of the fiberglass fibers 37 are affected by the needling process as they remain in a more random orientation. It should also be noted that during the needling process some fibers 37a are pushed into other layers such as the three-dimensional material layer 25 and the optional additional felt layer 50. Although not shown, small channels are created by the needles as they pass through these additional layers 25 and 50.

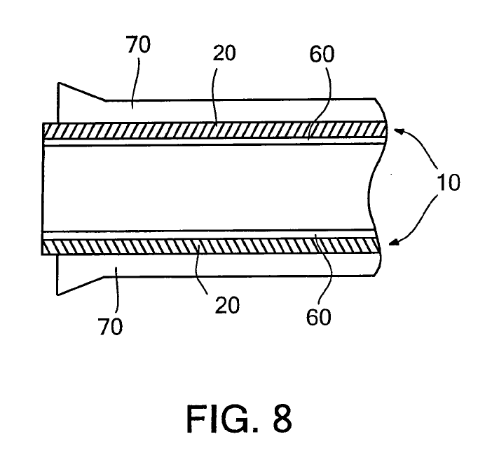

Once needling has taken place, the mat 20 may be rolled by a large roller for further compaction. This rolling and compaction process further pushes barbs 25a and fiberglass fibers 37a into the various layers 40, 35, 25, and 50. The needling may also occur through the second felt layer 50 from the side opposite the side closest to layer 40. There, some fibers 37c are pushed into first felt layer 40. Of course, this may also occur during the compaction process so an additional needling step may not be needed. Once the needling is complete, coating or cover layer 60 is added. Preferably, this layer 60 is not punctured so that it acts as a resin catch when the tube is inverted. See, for example, FIGS. 2 and 8.

As mentioned, the resin is preferably added by a pinch and roller process. This can be a separate step or may be part of the compaction process. The channels 37b, perpendicularly orientation fibers 37a, and three-dimensional material 25 all greatly enhance the flow of resin 65 through the felt layers 40, 50 to totally saturate the entire mat 20.

The particular components, compositions, properties, and/or other traits of resin 65 are selected based on the intended end-use environment, and corresponding desired use characteristics or regulated standards such as various ASTM standards, and/or others. For example, in some implementations, the member 10 and resin 65 are used in any one(s) of, e.g., oil pipe, HVAC duct, water main, gas main, potable water pipe, manhole line, sewer, industrial effluent lines, electrical conduit repair, and/or others as desired.

In some implementations, resin 65 is a nonstyrenated polyester, vinyl ester, or dicyclopentadiene (DCPD) resin. In particular, resin 65 can be a hydroxylated methacrylate monomer and a polymer selected from the group consisting of vinyl esters and DCPD, for example, a urethane acrylate and a polymer selected from the group consisting of polyesters, vinyl esters, and DCPD. Preferably, the ratio of the weights of monomer and polymer in the resin is in the range of from about 1:9 to 9:1, depending on the properties desired in the resin; the monomer can be hydroxyethyl methyl methacrylate (HEMA), hydroxyethyl propyl methacrylate (HEPMA), or a hydroxyethyl urethane acrylate. In other words, resin 65 can have at least one urethane acrylate monomer and at least one resin selected from the group consisting of polyesters, vinyl esters, and dicyclopentadiene (DCPD), and combinations thereof, wherein the ratio (w/w) of monomer to resin is between about 1:9 and 9:1 or alternatively wherein the ratio (w/w) of monomer to solid resin is at least about 3:7. Of course, other options are possible.

It was found that a suitable resin 65 can be any of a variety of nonstyrenated resins 65, but preferably have a lack of brittleness and good temperature performance or stability. A cross linked, nonstyrenated polyester urethane acrylate resin can be utilized which has a flex modulus of at least about 250,000 psi, a flexural strength of at least about 8000 psi, and a glass transition temperature of at least about 150 degrees F. For such underground plumbing-type, e.g., pipe rehabilitation implementations, it was discovered that a cross linked vinyl ester resin with a flex modulus of at least about 900,000 psi, a flexural strength of at least about 20,000 psi, and a glass transition temperature of at least about 450 degrees F. can prove particularly beneficial.

Furthermore, resin 65 preferably includes nonstyrenated polyester, vinyl ester, and DCPD resins that are characterized by significantly lower VOCs than conventional material resins. Such resins have been found to afford substantial desired performance characteristics for use with liner members 10 used to rehabilitate deteriorating underground piping systems.

Resin 65 may be made by, e.g., the steps of: (a) providing at least one monomer selected from the group consisting of hydroxylated methacrylate and urethane acrylate; and mixing at least one monomer of step (a) with at least one liquefied resin selected from the group consisting of an unsaturated polyester, a vinyl ester, and a DCPD resin under suitable reaction conditions. By suitable reaction conditions, it is meant that the polymers are prepared under conditions known to one of skill in the art.

Regarding the urethane acrylate used in making resin 65, it can be made by reacting an isocyanate with a methacrylate having a hydroxyl group under suitable reaction conditions well known to those skilled in the art to form a urethane acrylate. Urethane acrylate typically decreases brittleness in a polyester resin and enhances impact strength in a vinyl ester resin. A suitable urethane acrylate can be prepared by reacting an isocyanate with a hydroxylated methacrylate such as HEMA or HEPMA to form a urethane acrylate under suitable conditions well-known to one of skill in the art. Urethane acrylates suitable for use in the present invention may be obtained using reaction mixtures comprising HEMA or HEPMA in the range of from about 5% to about 80% and isocyanate in the range of from about 20% to about 95%. One means of obtaining a urethane acrylate suitable for use in the present invention is detailed in the examples below. Briefly, a blocked toluenediisocyanate (TDI) or a straight diphenylmethane diisocynate (MDI) having a percent activate isocyanate groups (NCO %) in the range of from about 1% to about 25% was slowly added to HEMA under agitation. The isocyanate was added gradually over a period of time of at least one hour. The final concentrations of the isocyanate and HEMA were 40% and 60% (w/w), respectively.

Various ones of the specific resins disclosed in U.S. Pat. No. 6,646,057, entitled Production Materials Having Unstyrenated Polyester or Vinyl Ester Resins, expressly incorporated herein in its entirety, have proven suitable for use with liner members 10 during underground pipe rehabilitation procedures.

However, with respect to underground pipe rehabilitation procedures, it was found desirable to slow, impede, retard, or otherwise control the rate of curing of the resin 65. To do so, the effect of, e.g., various peroxide initiators or photoinitiation is altered, reduced, or even temporarily mitigated, to control the rate of curing or resin 65. For example, ones of various blocked metal carboxylates, manganese, cobalt, or various Lewis acids such as lactic acid, can be used to influence the curing rate of resin 65. Regardless of the particular resin and curing activation and control methods, the curing temperature preferably reaches at least about 140 degrees F.

Regardless of the particular composition of the resin 65 and/or resin curing control factors or constituents, especially when used in underground rehabilitation procedures, the resins 65 preferably are low odor or odor free and classified as being within the (USA) Non-Regulated Non-Flammable OSHA Class 3B. Due to numerous risks associated with chemical leeching or wicking into soil and groundwater, in some implementations, the resins 65 preferably contain no solvents, no hazardous air pollutants (HAPs), and no volatile organic compounds (VOCs) nor emit VOCs during use, optionally contain less than 1% HAPs or VOCs.

Furthermore, in some implementations, the resins 65 define a solids yield that exceeds more than 90% solids, optionally 99% solids, or yield 100% solids, which can mitigate shrinkage during curing so that it is negligible, thereby minimizing infiltration between the liner and the pipe. The relatively high solid content of the resins 65 enable them to cure quickly and achieve suitable results, e.g., strength and/or other characteristics, while using relatively less resin 65.

In operation and use, the member 10 of the present invention is preferably fabricated off-site from the location where the pipe is to be rehabilitated. At the fabrication site, the manufacture includes fabricating a glass-reinforced member or liner 10 by preferably laying down a sheet or layer of polyester felt or fabric 40, a layer 35 of loose glass fibers 37 on top of the fabric 40, and a sheet 25 of three-dimensional polyester strand and fiberglass yarn on top of the fibers. Another layer of fabric 50 may then be added on top of the sheet 25. Then, the fabric and fibers are bonded (preferably by needling) to the sheet 25 to form a composite substrate or mat 20. The substrate 20 is then formed into a tube. This is accomplished by connecting, joining, or bonding the edges of the substrate 20, preferably, by an adhesive overlap. In other embodiments, flame joining or stitching may be used. The stitching may include, e.g., a prayer stitch with the edges forming a butt joint. Next, a resin is applied to the tube. A coating 60 may be added on the tube to retain the resin 65 in the tube.

At the rehabilitation site, the method of installation preferably includes inverting the tube into a pipe 70 to form an inside diameter liner 10. FIG. 8 shows a perspective cutaway view of the tube or pipe 70 with the member 10 inserted therein. When the mat 20 soaked with resin 65 (FIG. 2) is ready, the member 10 is inserted at the mouth of the pipe or tube 70. A gas is then preferably used to invert the member 10 into the tube 70. The tube preferably has its inner sidewalls completely covered with the member 10. A light and a camera are then preferably inserted into the tube to ensure that the member 10 is affixed to the sidewalls of the tube 70. Preferably, the member 10 does not have any wrinkles and no resin 65 is leaking, e.g., through cover 60. After inversion, the coating 60 is now on the inside of the inverted tube member 10. As such, when the liner installation is inspected with the camera, the thin, flexible liner of the invention defies visually conspicuous dimpling, or other visual indicators, at intersection pipe segments. In other words, the thin, flexible characteristics of the liner are clearly visible through the camera, whereby the operator can easily identify such dimples and thus identify locations of hook-ups to homes or other incoming pipe systems.

Once the member 10 is in place and has been inspected, the resin 65 is cured to harden the member 10 in place within pipe 70. In one embodiment, an ultraviolet light cures the resin in the liner 10 to form a hard inner shell within the pipe 70. Alternatively, the liner 10 is cured with hot water or steam.

Once in place, the cured inner knit/weave structure of the liner 10 of the present invention provides 0 degrees, 45 degrees, 90 degrees x-y-z axis strength. Further, given the makeup of the inventive liner, pipe rehabilitation crews do not need as much material to rehab a pipe. Certain preferred steps have been found in testing the liner. For example, in one preferred embodiment, the PET fiber used in the mat is preferably not coated as it typically is with a fatty acid ester coating. The fatty acid ester coating causes problems with the joining of the substrate or laminate and, thus, if it is added, the laminate may not be properly formed.

It has also been found that the cover and other layers which make up the laminate must be free of any debris or other foreign particles such as dust or dirt, which might prohibit the proper joining of the layers of the laminate. Such debris and other foreign materials might also affect the liner's ability to pass potable water testing certifications. It is also important to ensure that the needling of the various layers is done to the proper density. Such needling allows for proper formation of a tightly configured laminate. Further, when the layers, such as the fabric, are run through cutting and slitting operations, it is important that the tensioning on the fabric is appropriate. This proper tension may be applied by having a tension applied to the full length of the roll of fabric. If improper tension is applied to the fabric or another layer, strands of fiber may be inadvertently stretched or torn which would cause the fabric to lose some of its strength and/or become “open faced”. In some applications, this might be desirable because it may lead to better joining between the fiber layers. However, in other applications where strength is necessary to ensure proper burst pressure of the liner once it is in place for high-pressure applications, broken or stretched strands would be highly undesirable. Thus, as can be seen, it is important to maintain proper quality control measures in laminate manufacture depending on the end user application of the liner.

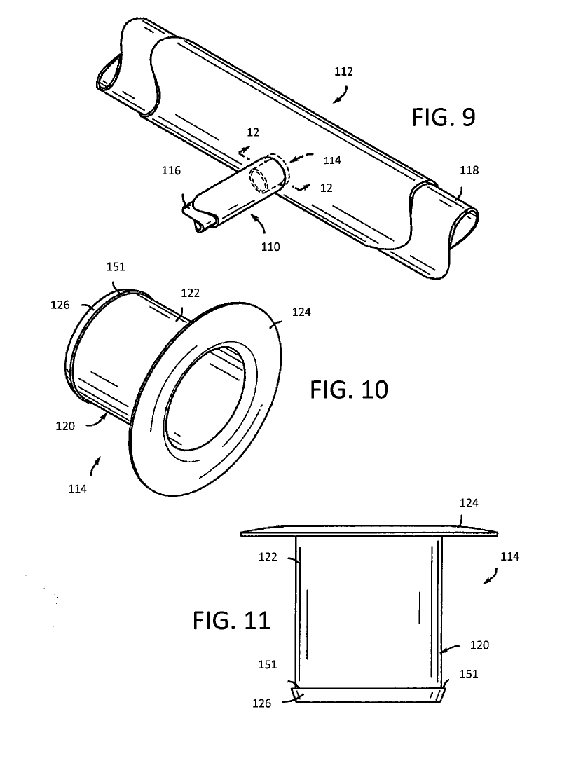

Referring now to FIG. 9, a lateral pipe 110 is shown fluidly coupled to a main pipe 112. A connector 114 interconnects the lateral pipe 110 and the main pipe 112, as will be described more fully below. In the illustrated example, the lateral pipe 110 and the main pipe 112 have been rehabilitated and thus include a liner 116 and 18, respectively. The liners 116, 118 may be put in place in a conventional manner. For example, in one preferred embodiment, the liners 116, 118 are impregnated with a resin that when cures bonds the liner to the inner walls of the its respective pipe. One known liner installation process uses highly pressured air passed through the pipes to force the liners against the inner walls of the pipes. When a curing agent, such as heated water, is then passed through the pipes, the resin will cure and bond the liners to the inner walls of the pipes. It is understood that other types of rehabilitation techniques and devices may be used. Moreover, it is understood that the connector 114 may be used to connect non-rehabilitated pipes, or non-rehabilitated portions of otherwise rehabilitated pipes. Further, it is understood that the invention may be used to connect a rehabilitated pipe with a non-rehabilitated pipe. Also, it is understood that the invention may be used with liners of various constructions. One exemplary liner construction is disclosed in U.S. Pub. No. 2008/0277012, the disclosure of which is incorporated herein.

In the illustrated example, the lateral pipe 110 extends from the main pipe 112 at a generally right angle. However, it is understood that the connector 114 may be constructed such that the lateral pipe 110 is at an acute or obtuse angle relative to the main pipe 112.

With additional reference to FIGS. 10 and 11, the connector 114 has an elongated and hollow tubular body 120 defined by annular wall 122. An annular flange 124 is formed at one end of the tubular body 120 and a tapered edge 126 is formed at the opposite end. In one exemplary embodiment, the length of the tubular body 120 together with the tapered edge 126 is approximately 1.50 inches; the tapered edge 126 has a length of approximately 0.13 inches, and the tapered edge tapers inwardly at a slope of approximately 5.0 degrees. In this exemplary embodiment, the thickness of the annular wall 122 is 0.03 inches and the thickness of the annular flange 124 is 0.09 inches. The outer diameter of the tubular body 120 is preferably 1.315 inches and the outer diameter of the annular flange 124 is preferably 2.32 inches. In one preferred embodiment, the tapered edge 26 extends about 0.03 inches from the outer portion of the annular wall 22 as shown in FIG. 3 to act as a catch or barb 151 to prevent removal. It is understood that the above-recited dimensions are merely examples and that a connector having different dimensions is within the scope of the invention.

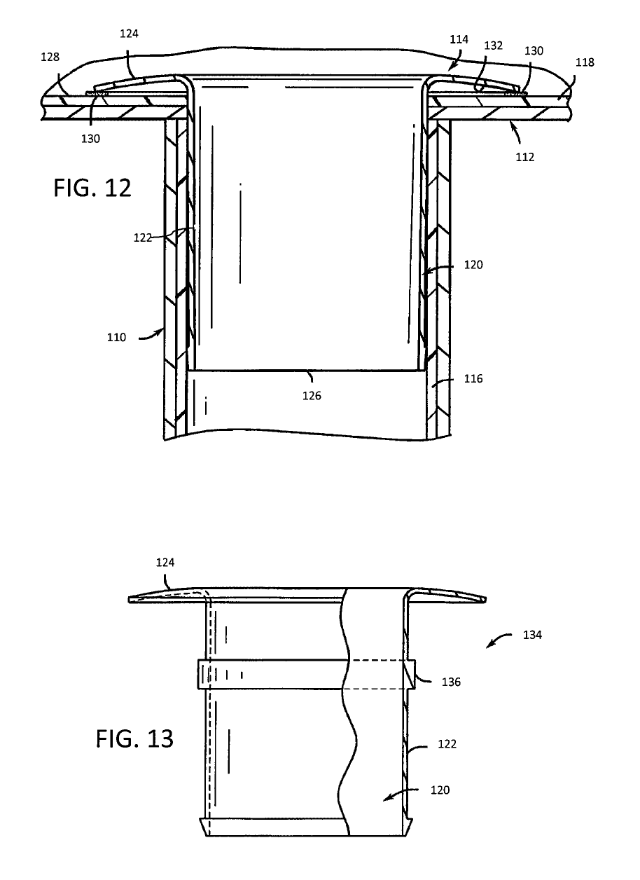

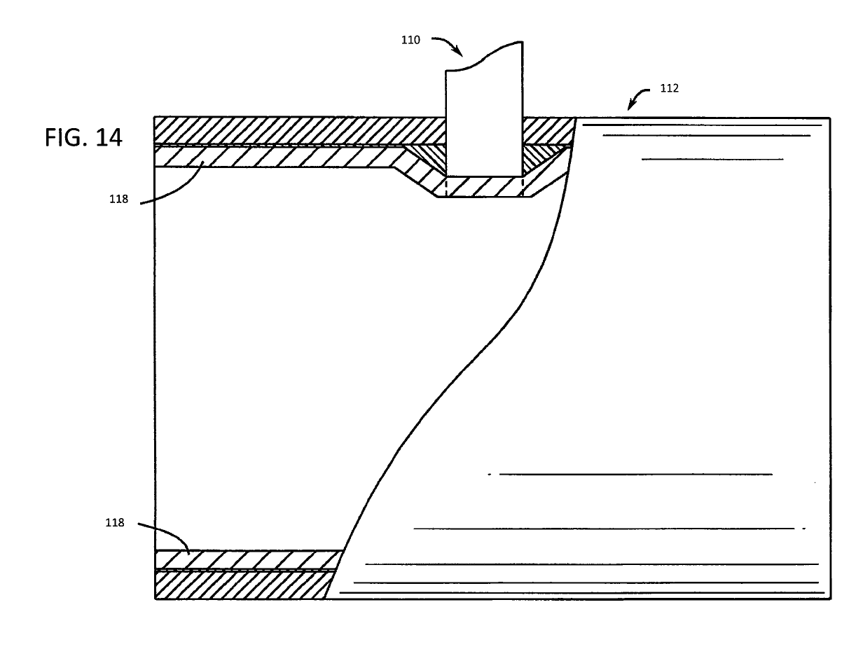

Referring now to FIG. 12, a section view taken along line 12-12 of FIG. 9 shows how the connector 114 of the present invention may be used to interconnect lateral pipe 110 and main pipe 112. It will be appreciated that an opening must first be formed in the main pipe 112. Preferably, the opening is formed to have a diameter that is slightly larger than the diameter of the tubular body 120 of the connector 114. The opening may be formed in any one of a number of conventional ways.

The connector 114 is designed such that the tubular body 120 extends through the opening and the annular flange 124 is held against the inner annular surface 128 of the liner 118. For a non-rehabilitated pipe, the annular flange 124 would be held directly against the inner annular surface of the main pipe 112. To assist with the connection of the flange 124 to the liner 118 and thus the connection of the connector 114 to the main pipe 112, a bonding adhesive 130 is placed on the backside 132 of the flange 124 such that when the flange 124 is pressed against the liner 118 (or main pipe 112) the flange 124 will be glued in place to the liner 118. Preferably, an anaerobic adhesive 130 is used, but it is understood that other types of adhesives, epoxies, glues, and the like may be used. In addition to assisting with the securing the flange 124 to the liner 118, the adhesive also provides a seal or gasket against leakage at the opening.

The tubular body 120 is adapted to engage an end portion of the lateral pipe 110. Preferably, the diameter of the lateral pipe 110 is slightly more than outer diameter of the tubular body 120 so that a snug fitting between the tubular body 120 and the lateral pipe 110 is made. The narrowed diameter of the tubular body 120 provided by the inwardly tapered edge 126 eases the sliding of the lateral pipe 110 onto the tubular body 120.

It will thus be appreciated that the connector 114 is designed to be loaded into place from within the main pipe 112. In a preferred embodiment, the connector 114 is held by a robotic device (not shown) that is placed within the main pipe 112 and is translated along the length of the main pipe 112 in a conventional manner until generally adjacent a lateral opening in the main pipe 112. Preferably, the described adhesive is applied onto the flange 124 before the robotic device is translated within the main pipe 112, but it is understood that the robotic device or other remote controlled device may be capable of applying the adhesive 130 at the use site. With the adhesive 130 applied, the tubular body 120 is aligned with and then passed through the opening until the flange 124 engages the inner surface 128 of the liner 118 (or the main pipe 112). It is also contemplated that the adhesive 130 could be applied to the liner 118 proximate the opening instead of or in addition to the adhesive 130 applied to the flange 124. In a preferred embodiment, the flange 124 is pressed against the inner surface 128 under a relatively high pressure, such as 150 psi. Preferably, the connector 114 is pressed into place such that portions of the flange 124 conform to the curvature of the inner surface 128 and thus mechanically engage the inner surface 128. In this regard, a mechanical as well as a chemical bond is formed between the connector 114 and the main pipe 112.

Once the adhesive has cured, a lateral pipe 110 may then be placed over the tubular body 120. In one preferred installation process, the pressure on the connector 114 by the robotic device is maintained as the lateral pipe 110 is installed to prevent any breaking away of the connector 114 from the main pipe 112. It is also understood that adhesive may also be placed on the tubular body to assist with the coupling between the connector and the main pipe as well as the lateral pipe.

FIG. 13 illustrates a connector 134 according to another embodiment of the invention. In this alternate embodiment, the connector 134 is similar in construction to the connector 114 previously described, but includes an additional annular ring 136 formed circumferentially around the tubular body 120. The annular ring 136 is operative as a catch when a flexible hose or tube is connected as a lateral to the main pipe 112 and thus helps prevent the lateral from sliding off of the tubular body 120. More particularly, when a lateral hose is slid onto the tubular body, to complete the installation, the lateral hose must be pulled over the annular ring 136. The lateral hose may then be clamped in a known manner to the tubular body 120 of the connector 114.

The position of the annular ring 136 shown in FIG. 13 is merely an example and it is understood that the annular ring 136 may be placed at different positions along the tubular body 120 than that shown in the figure. In addition, multiple annular rings may be formed on the tubular body 120.

In at least one embodiment, connectors 114 and 134 are formed of a rust-resistant metal alloy such as 304 or 316 stainless steel. However, it is understood that other alloys may be used as well as non-metal materials, such as a plastic polymer material. Further, while a number of different adhesives may be used, in one embodiment, the adhesive is hydrophilic adhesive that expands slightly when wet to not only provide adhesion but also to serve as a seal. It should be noted that the adhesive is used to generally provide more of a chemical coupling (about 50%) while the flange 126 provides more of a mechanical coupling (about 50%).

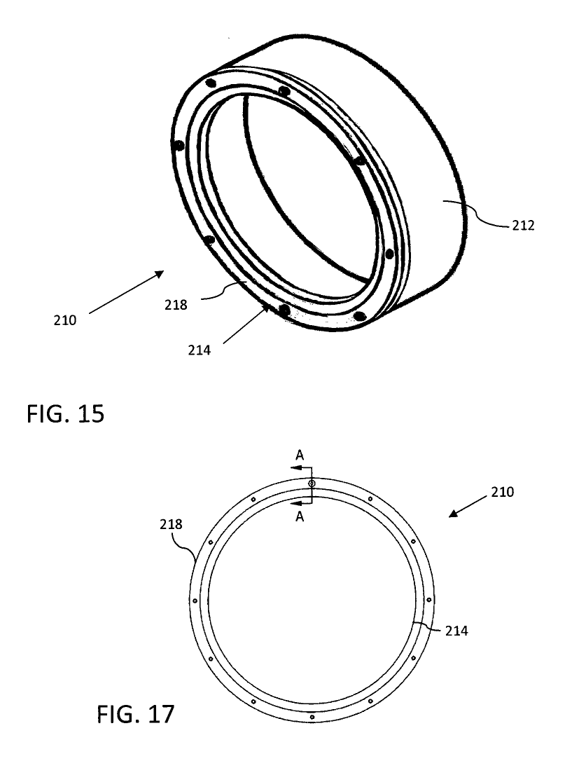

Referring now to FIGS. 15-19, an end fitting or end sealing assembly 210 for a liner system like that of the present invention is provided. Referring initially to FIG. 15, a partial isometric view of an end of a pipe 212 is shown. Pipe 212 may be a main pipe or a lateral pipe. Pipe 212 may be pressurized. Pipe 212 may be a sewer, water, or gas pipe. In particular, pipe 212 may be any kind of distribution pipe or line operating under pressure such as, but not limited to, water, gas and other fluid pipes and pipes for the travel of at least semi-solid materials such as sewage and the like, i.e., forced main lines. End sealing assembly 210 is configured to prevent fluids and at least semi-solid materials from penetrating a space between the cured-in-place liner assembly 214 and the pipe 212. This prevents damage to the pipe 212 that can be caused by prolonged exposure to fluids and at least semi-solid materials. Moreover, it increases the life span of the cured-in-place liner assembly 214 in that the cured-in-place liner assembly 214 need not be replaced as often because damage to pipe 212 is mititaged by the end sealing assembly 210.

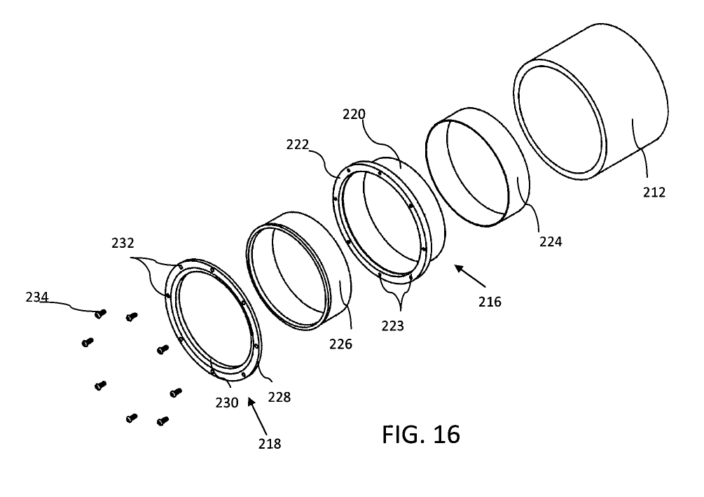

Referring now to FIG. 16, an exploded view of the end sealing assembly 210 is provided. End sealing assembly 210 may have a two-piece construction including a first, inner piece or base 216 and a second, outer piece or cap 218. End sealing assembly 210 may alternatively have a unitary construction or may comprise one or more additional pieces. Base 216 includes a generally cylindrical hollow body 220, which may be integrally formed with an annular flange 222. Annular flange 222 may include a number of apertures 223 disposed about the circumference of the annular flange 222 to receive fasteners to couple the base 216 to the cap 218 as will be discussed further herein. Base 216 may be constructed from a metal such as stainless steel or, alternatively, a plastic, or the like. Base 216 may be constructed from 316 stainless steel in one embodiment of the invention.

A liner body 226 is received within base 216 and positioned adjacent to the felt sleeve 224 such that the felt sleeve 224 overlies the liner body 226. Liner body 226 may be constructed of glass fibers and a three-dimensional knit material comprising polyester and fiber strands. Liner body 226 and felt sleeve 224 are generally configured to be combined to form a composite substrate during the curing process as is generally understood. The felt sleeve, glass fibers and knit material may be combined by way of a process such as needle punching or the like. The needle punching may orient the glass fibers in a generally radial direction with respect to the composite substrate. A resin may be provided for curing the liner body 226 within pipe 212 as is generally understood. The resin is generally retained within the liner body 226 or felt sleeve 224 by way of a coating and/or foilLiner body 226 may be a composite impregnated liner of the kind generally known in the art and previously discussed in the present application. Moreover, liner body 226 may be an inverted cured in place pipe liner. Excess portions of liner body 226 may be trimmed as desired in constructing end sealing assembly 210. A caulking material may be applied to liner body 226 for providing a sealant between the liner body 226 and the end sealing assembly 210 to prevent the penetration of fluids and at least semi-solid materials through the end sealing assembly 210.

Cap 218 of end sealing assembly 210 may include a generally hollow, cylindrical body 228. Body 228 is coupled to an annular flange 230 positioned outward of body 228 with respect to pipe 212. Annular flange 230 may be a stepped ring. Annular flange 230 and body 228 may be integrally formed with one another. Cap 218, may be similarly constructed as base 216. That is, cap 218 may be constructed from any metal, plastic or other material. Annular flange 230 may include a number of apertures 232 disposed around a surface of flange 230 for receiving a number of corresponding fasteners 234. Fasteners 234 may be bolts, screws, or the like. Fasteners 234 are insertable through apertures 232 such that ends of fasteners 234 may be received by corresponding apertures 223 in base 216 to thereby couple base 216 to cap 218. Body 228 of cap 218 is configured to receive a portion of liner body 226. In particular, liner body 226 is pulled over body 228 to thereby couple liner body 226 to body 228. Body 228 may be a stepped ring much like the body 220 of base 216 and may operate similarly in use.

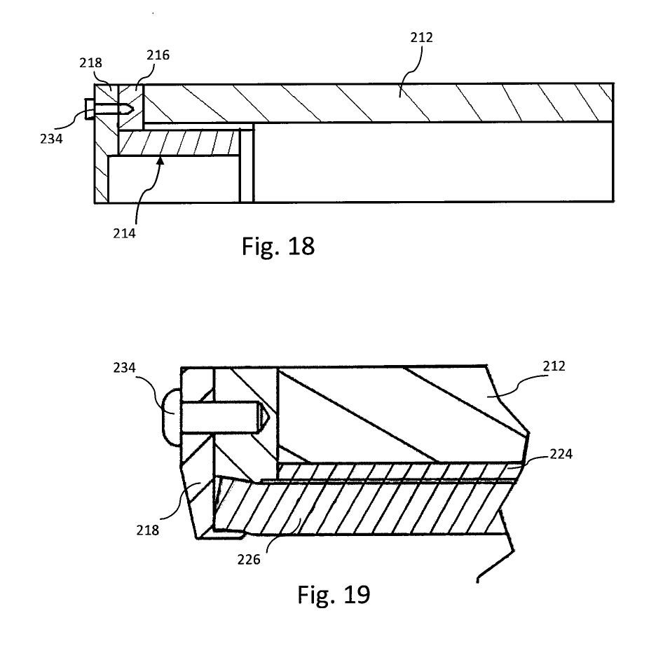

Referring now to FIGS. 17-19, the coupling of the end sealing assembly 210 with the liner body 226, felt sleeve 224 and pipe 212 is shown. As can be seen from view of FIG. 19, cap 218 defines a void between cap 218 and base 216 in which a portion of an edge of liner body 226 is secured. Felt sleeve 224 is sandwiched between pipe 212 and liner body 226 to thereby secure the sleeve therebetween. As shown in FIGS. 18-19, fastener 234 may be a screw such as, e.g., a ¼ inch button head screw. Base 216 is positioned flush against an end of pipe 212 and cap 218 is received over the base 216 and defines a cap over the end of pipe 212. In this manner, end sealing assembly 210 defines a structure configured for preventing the penetration of fluids and at least semi-solid materials through ends of the pipe 212 to thereby prevent fluids and at least semi-solid materials from becoming lodged between the liner assembly and the pipe 212.

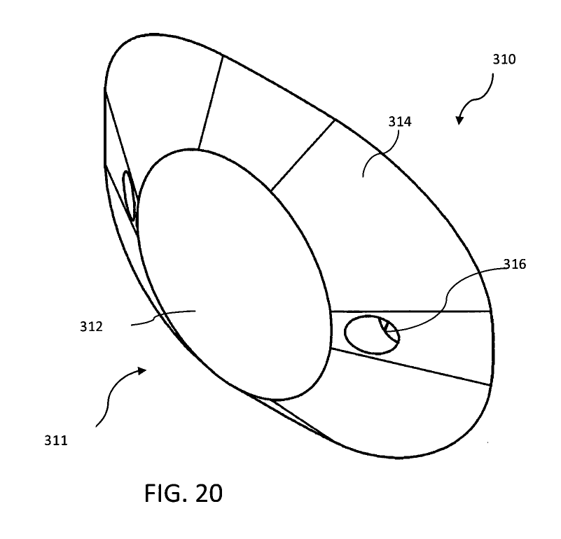

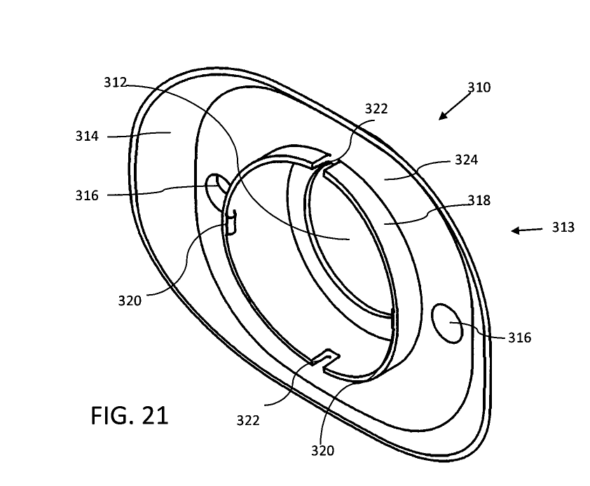

Referring now to FIGS. 20-23, a sealing member 310 according to the present invention is illustrated. Sealing member 310 may be constructed from a conventional plastic material. In particular, sealing member 310 is constructed from a plastic configured to flexibly conform to an end of a lateral pipe, i.e., a tap, while also sealing the lateral pipe from the main pipe.

Referring first to FIG. 20, a first side 311 of sealing member 310 includes a generally planar central portion 312 surrounded by a circumferentially extending flange portion 314. Central portion 312 may be generally circular and sized for placement over the tap of a lateral pipe as will be discussed. Flange portion 314 is configured to surround the edges of the tap for placement thereover. A pair of apertures 316 extend through sealing member 310 and are positioned on opposite sides of the sealing member 310. Apertures 316 are configured for engagement by a fixture tool assembly as will be discussed in further detail herein. Of course, it is understood that sealing member 310 may include only a single aperture 316 or any number of additional apertures 316 for engagement by the placement tool.

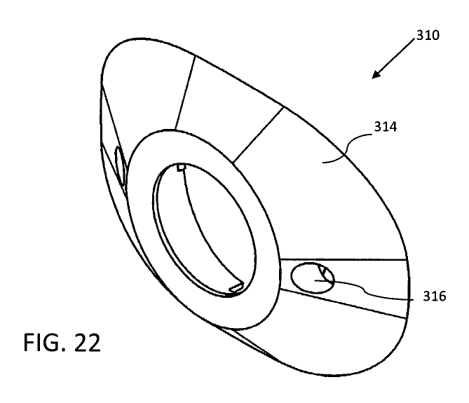

Referring now to FIG. 21, an opposing, second or rear side 313 is illustrated. Second side 313 includes a generally cylindrical tap engaging portion 318, which extends rearwardly therefrom. Tap engaging portion 318 may be integrally formed with the second side 313 or otherwise coupled thereto. Tap engaging portion 318 is configured to engage an end of the tap of the lateral pipe to secure sealing member 310 to the lateral pipe. Tap engaging portion 318 includes a pair of opposing tabs 320 disposed on an inner wall of tap engaging portion 318. Tabs 320 may be generally integrally formed with the tap engaging portion 318. Tabs 320 are configured for engaging the threads of an end of the tap of the lateral pipe. Tap engaging portion 318 is simply slid over the end of the tap to be sealed until the central portion 312 abuts up against or is positioned adjacent to the end of the tap. To secure the sealing member 310 with the tap, the tabs 320 engage the threads on the end of the tap. In particular, tabs 320 are configured for snap fitting to the threads of the tap of the lateral pipe. A pair of opposing slits 322 may also be provided in the tap engaging portion 318. In particular, slits 322 are provided generally 90 degrees with respect to tabs 320. Slits 322 allow for expansion of tap engaging portion 318 over the end of the tap of the lateral pipe. In particular, as taps vary in size, the slits 322 provide flexibility so that the sealing member 310 may accommodate a number of differently sized taps. Slits 322 extend over a portion of a length of tap engaging portion 318. In particular, slits 322 extend from a rearward edge of tap engaging portion 318 and extend generally forwardly a predetermined length. By lengthening or shortening the length of slits 322, the expandability of tap engaging portion 318 may be increased or decreased respectively. Flange portion 314 of sealing member 310 may have any number of constructions configured to enable sealing member 310 to sealingly conform to the size and configuration of a particular tap.

In one embodiment, the flanges have a slope of approximately 0.80 inches, width of approximately between 0.015 and 0.6 inches, length of approximately between 0.20 and 0.80 inches and a depth of approximately 0.25-1.00 inches. Sealing member 310 has a width of approximately between 0.25-1 inches, a height of approximately between 1-4.50 inches, and a length of approximately between 1.50-6 inches. Tap engaging portion 318 has a diameter between approximately 0.65-2.75 inches. Apertures 316 have a diameter of approximately between 0.165-0.50 inches. The distance between the tap engaging portion 318 and an outer edge of flange portion 314 is approximately between 0.20-0.80 inches.

Second side 313 of sealing member 310 further defines an intermediate portion 324 between the flange portion 314 and the tap engaging portion 318. Intermediate portion 324 may extend around the entire circumference of tap engaging portion 318 or may be positioned over only a portion of the area between the tap engaging portion 318 and the flange portion 314. The intermediate portion 324 is generally configured for receiving an application of a sealant of the kind generally known in the art. The sealant is provided to further prevent the intrusion of resin during the curing process into the lateral pipe as will be discussed. Intermediate portion 324 may be cuffed or shaped to resemble a cuff or have a generally concave shape to facilitate the application of sealant therein.

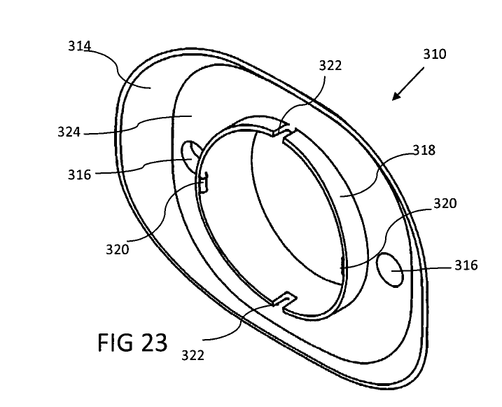

In operation, sealing member 310 is coupled to a tap of a lateral pipe prior to the curing of the liner inserted within the main pipe coupled to the lateral pipe. The sealing member 310 is configured to prevent the penetration of sealant or other unwanted materials into the tap of the lateral pipe during the curing process. It is generally known that during the curing process, if the tap is not sealed, resin can become lodged in the taps of the lateral pipes thereby sealing the lateral pipes such that water, gas, sewage, and the like cannot flow between the lateral pipe and the main pipe. Accordingly, users of the lateral pipe can experience unwanted sewage backups or may be prevented from receiving water or gas as desired. Once the curing process is complete, the central portion 312 of sealing member 310 is simply removed by for example, a conventional cutting tool or the like to allow fluid flow between the main pipe and the lateral pipe. Turning now to FIGS. 22-23, sealing member 310 is shown with central portion 312 removed. Thus, once central portion 312 has been removed, water, gas, sewage, and the like are free to flow between the main pipe and the lateral pipe.

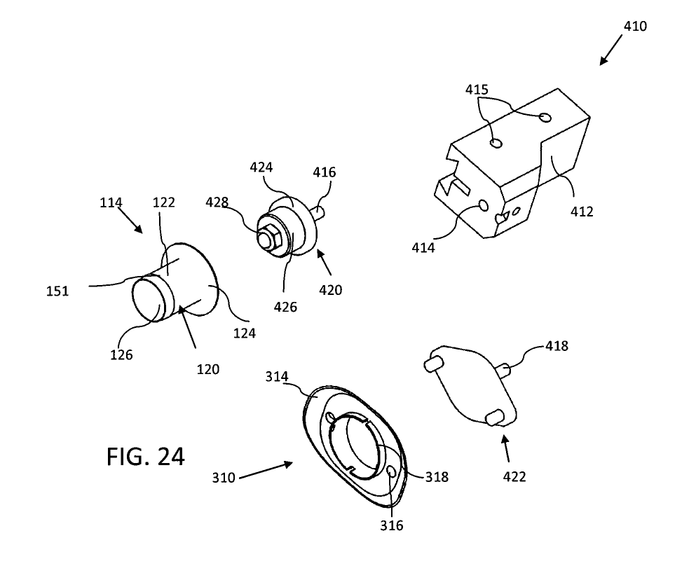

Referring now to FIG. 24, a system 410 for installing a connector 114 and/or a sealing member 310 is illustrated. System 410 includes a coupling member 412 in the form of a block. Coupling member 412 may be sized and shaped in any number of ways in keeping with the present invention. Coupling member 412 includes an aperture 414 on a front surface thereof. Aperture 414 is sized, shaped, and configured for receiving projections 416, 418 of various fixture tools like exemplary fixture tools 420, 422, connector fixture tool 420 and sealing member fixture tool 422, respectively. Coupling member 412 is adapted to be coupled to an arm of a robotic device (not shown) configured for installing the connector 114 and sealing member 310 as is generally understood in the art. Coupling member 412 may include a number of additional apertures 415 for attaching coupling member 412 to the robotic device.

Connector fixture tool 420 includes a rearwardly extending projection 416 configured for coupling to one of the apertures 414 of coupling member 412. Projection 416 may include means for locking in place within the aperture 414. For instance, projection 416 may have a tab or other means for interacting with a portion of the aperture 414 to secure the projection 416 in place when inserted into one of the apertures 414. Projection 416 may be a bolt or other fastener and may extend through an entire length of connector fixture tool such that one end is securable to coupling member 412 and an opposing end extends out of the connector fixture tool to allow for projection 416 to be extended and retracted as desired. Connector fixture tool 420 includes a medially positioned disc 424 that is sized and shaped for abutting up against annular flange 124 of connector 114. A generally cylindrical engagement body 426 configured to be received within connector 114 is positioned forward with respect to disc 424. Engagement body 426 is sized and shaped for insertion into an interior of connector 114 so that connector 114 is securely carried by engagement member 426. A nut 428 or similar member is coupled onto an end of the projection 416 extending forwardly from connector fixture tool to thereby secure body 426 with respect to disc 424.

Thus, in operation, connector fixture tool 420 is coupled to coupling member 412 by inserting one end of projection 416 into aperture 414. Body 426 is then inserted into an end of connector 114 through the annular flange 124 and into the tubular body 120 until the annular flange 124 comes into contact with disc 424. Body 426 is configured so that its outer diameter is slightly less than that of the inner diameter of the tubular body 120. In this manner, the connector 114 is securely held over the body 426 during installation of the connector 114. Once the connector 114 is secured to connector fixture member 420 and thereby to coupling member 412, the connector 114 is moved by the robotic apparatus to an installation location, e.g., the tap of a lateral pipe in communication with a main pipe as previous discussed. The connector 114 is then positioned by the robotic apparatus and secured in place as previously discussed.

Sealing member fixture tool 422 is similarly configured for being coupled to coupling member 412 for operation by the robotic device. Sealing member fixture tool includes a projection 418 for attaching to the coupling member 412 in much the same manner as connector fixture tool 420. Sealing member fixture tool 422 further includes a generally flat central block 430. Block 430 has a generally square cross section and may have rounded corners. Block 430 is configured for carrying a pair of forwardly extending, opposing front projections 432. Front projections 432 are configured to be received by the apertures 316 of sealing member 310 as previously discussed. Thus, in operation, sealing member fixture tool 422 is connected to coupling member 412 by way of projection 418 and secured in place. Sealing member 310 is attached to the sealing member fixture tool by inserting the forward projections 432 through the apertures 316 thereof. Once the sealing member 310 is secured to the sealing member fixture tool, the robotic device is manipulated so as to deliver the sealing member 310 to the desired location, i.e., a tap of a lateral pipe as previously discussed.

Fixture tools 420, 422 may take on any number of varying constructions as is readily understood. The foregoing described constructions are but one manner of carrying out the coupling of the connector 114 and sealing member 310 to a robotic device for installation thereof. Fixture tools 420, 422 may be constructed from a number of materials including, but not limited to, metals, plastics, combinations thereof, and the like. Fixture tools 420, 422 may be constructed from the same or different materials with respect to one another. Similarly coupling member 412 may be constructed from any number of materials and may be constructed from the same or different materials as the fixture tools 420, 422.

I claim:

1. A cured-in-place liner system comprising:
a) a composite substrate liner including a felt sleeve and a liner body; and
b) an end sealing assembly coupled to the composite substrate and including a base and a cap, the base and cap each having a cylindrical, inwardly extending body and an annular flange positioned outward with respect to the body and coupled to one another for being received with an end of a pipe to form a seal between the composite substrate liner and the pipe to prevent fluids or at least semi-solid materials from penetrating the liner.

2. The cured-in-place liner system of claim 1, wherein the felt sleeve is configured to be coupled to the base of the end sealing assembly.

3. The cured-in-place liner system of claim 2, wherein the felt sleeve is received over the body of the base of the end-fitting assembly.

4. The cured-in-place liner system of claim 1, wherein the body of the base comprises a stepped ring having a circumference that increasingly narrows moving inwardly along the body.

5. The cured-in-place liner system of claim 1, wherein the cap defines a void on an inwardly facing side of the cap and wherein a portion of the liner body is received within the void to thereby secure the liner body to the cap.

6. The cured-in-place liner system of claim 5, wherein a caulk is applied to a surface of the liner body received within the void to provide a sealing coupling between the cap and the liner body, and wherein the cap and the base of the end sealing assembly are coupled to one of another by a plurality of fasteners received through the annular flanges thereof.

7. The cured-in-place liner system of claim 1, further comprising a sealing member for sealing a lateral pipe from a main pipe, the sealing member comprising,
i) a selectively removable central portion configured to be positioned over a tap of the lateral pipe;
ii) a circumferentially extending flange coupled to the central portion and extending rearwardly with respect to the central portion;
iii) a tap engaging portion coupled to a rear side of the sealing member and extending rearwardly therefrom, the tap engaging portion being generally aligned with the central portion and selectively engageable with an outer diameter of the tap to thereby position the central portion over the tap; and
iv) at least one tab coupled to the tap engaging portion and engageable with a thread of the tap of the lateral pipe to secure the sealing member to thereto.

8. An apparatus for sealing a lateral pipe with respect to a main pipe comprising:
a) a selectively removable central portion configured to be positioned over a tap of the lateral pipe to provide a seal between the lateral pipe and the main pipe;
b) a circumferentially extending flange coupled to the central portion and extending rearwardly with respect to the central portion;
c) a tap engaging portion coupled to a rear side of the apparatus, generally aligned with the central portion, and extending rearwardly from the rear side, the tap engaging portion configured to be pulled over an outer diameter of the tap of the lateral pipe so as to position the central portion over the tap; and
d) at least one tab coupled to the tap engaging portion and configured for securing the tap engaging portion to a thread of the tap of the lateral pipe.

9. The apparatus of claim 8, wherein the at least one tab comprises a pair of tabs positioned on opposing sides of the tap engaging portion.

10. The apparatus of claim 9, wherein the tap engaging portion includes a pair of slits formed over a portion of a length of the tap engaging portion to allow the tap engaging portion to expand to fit over the tap of the lateral pipe.

11. The apparatus of claim 10, wherein each of the slits of the pair of slits are positioned approximately 90 degrees offset from each of the tabs of the pair of tabs.

12. The apparatus of claim 8, wherein the central portion is shaped to correspond to the shape of the tap of the lateral pipe.

13. The apparatus of claim 12, wherein the tap engaging portion defines a shape approximating that of the central portion, and wherein the central portion is substantially circular.

14. The apparatus of claim 8, further comprising a cured-in-place liner system comprising,
i) a composite substrate liner including a felt sleeve and a liner body; and
ii) an end sealing assembly coupled to the composite substrate and including a base and a cap, each of the base and the cap including a cylindrical, inwardly extending body and an annular flange positioned outward with respect to the body, wherein the cap and the body are engageable with one another and received in an end of a pipe to form a seal between the composite substrate liner and the pipe.

15. The apparatus of claim 8, further comprising a pair of opposed apertures formed through a portion of the apparatus and configured for engagement by a fixture tool for installing the apparatus at a desired location.

16. The apparatus of claim 15, wherein the fixture tool is selectively attachable to a coupling member and includes means for engaging the pair of opposed apertures.

17. The apparatus of claim 8, further comprising an intermediate portion disposed between the tap engaging portion and the flange and configured for receiving a sealant configured to bond the apparatus to the tap of the lateral pipe.

18. The apparatus of claim 8, wherein the central portion is configured for removal by a cutting tool configured to remove the portion of the central portion received over the tap of the lateral pipe.

19. A rehabilitation system for a main pipe interconnected with one or more lateral pipes, the rehabilitation system comprising:
a) a composite substrate comprising a felt sleeve and a liner body secured to an inner diameter of the main pipe;
b) an end sealing assembly coupled to an end of the main pipe and the composite substrate to provide a seal between the composite substrate and the main pipe;
c) at least one sealing member, each of the at least one sealing members coupled to a tap of the one or more lateral pipes to prevent materials from entering the one or more lateral pipes during a curing process of the composite substrate; and
d) a fixture tool selectively coupled to the at least one sealing member to enable installation of the at least one sealing member.

20. The rehabilitation system of claim 19, wherein,
the composite substrate comprises a cured-in-place liner system;
the end sealing assembly includes a base and a cap each having a cylindrical, inwardly extending body and an annular flange coupled to an outer end thereof with respect to the body, the base and cap coupled to one another by a plurality of fasteners received through the annular flanges of the base and the cap and sealingly coupled to the cured-in-place liner system to prevent water from entering an area between the cured-in-place liner system and the main pipe; and
the at least one sealing member includes a central portion that is selectively removable to allow communication between the main pipe and the lateral pipe to which it is coupled and a tap engaging portion aligned with the central portion and disposed on an opposing side of the sealing member with respect thereto, the tap engaging portion coupled to the tap of the lateral pipe and including one or more tabs carried on a surface of the tap engaging portion and engaged with a thread of the tap to secure the sealing member to the tap of the lateral pipe.
